(19) United States
(12) Patent Application Publication
(10) Pub. No.: US 2011/0095503 A1
(43) Pub. Date: Apr. 28, 2011

(54) DROP SPINDLE INDEPENDENT SUSPENSION SYSTEM

(75) Inventors: Cully B. DODD, McKinney, TX (US); Emmanuel Ramon, Carrollton, TX (US)

(73) Assignee: WATSON & CHALIN MANUFACTURING, INC., McKinney, TX (US)

(21) Appl. No.: 12/603,985

(22) Filed: Oct. 22, 2009

(51) Int. Cl. B60G 3/20; B60G 9/02

(52) U.S. Cl. 280/124.135; 280/124.116

(57) ABSTRACT

A suspension system includes a member which extends laterally relative to a frame of a vehicle. At least one spindle carrier may pivot about the member. Multiple spindle carriers may be pivotably mounted at respective opposite ends of the member. A spindle carrier may rotate about an axis which is collinear with and/or parallel to an axis of the member.

### BACKGROUND

This disclosure relates generally to vehicle suspension systems and, in an example described below, more particularly provides a drop spindle independent suspension system.

It is continually desirable to provide more light weight, reliable and reduced cost suspension systems for wheeled vehicles, including light trailers. Drop spindle independent suspension systems are being used more frequently, but typical suspension systems of this type suffer from certain drawbacks. These drawbacks include, but are not limited to, an excessive number of components, difficult assembly and excessive time needed to manufacture and install the suspension systems.

Therefore, it will be appreciated that improvements are needed in the art of suspension systems.

### SUMMARY

In the disclosure below, improvements are described for the art of suspension systems. One example is described below in which a spindle carrier is pivotably mounted to a member which extends laterally relative to a vehicle frame. Another example is described below in which the spindle carrier rotates about the member itself, and about an axis which extends laterally relative to the vehicle frame.

In one aspect, a suspension system for a vehicle is provided. The suspension system includes a member which extends laterally relative to a frame of the vehicle, and at least one spindle carrier which pivots about the member.

In another aspect, a suspension system for a vehicle includes the member which extends laterally relative to the frame of the vehicle, and multiple spindle carriers. Each of the spindle carriers is pivotably mounted at a respective opposite end of the member.

In yet another aspect, a suspension system for a vehicle includes the member which extends laterally relative to the frame of the vehicle, with the member having an axis. At least one spindle carrier rotates about an axis which is collinear with and/or parallel to the member axis.

These and other features, advantages and benefits will become apparent to one of ordinary skill in the art upon careful consideration of the detailed description of representative examples below and the accompanying drawings, in which similar elements are indicated in the various figures using the same reference numbers.

### BRIEF DESCRIPTION OF THE DRAWINGS

FIG. 1 is a side view of a vehicle which can incorporate principles of the present disclosure.

FIG. 2 is an enlarged scale top view of a suspension system which may be used with the vehicle of FIG. 1.

FIG. 3 is a further enlarged scale rear perspective view of the suspension system.

FIG. 4 is an outer side view of the suspension system.

FIG. 5 is an inner side view of the suspension system.

FIG. 6 is a bottom view of the suspension system.

FIG. 7 is a rear view of the suspension system.

FIGS. 8 & 9 are outer side and perspective views of another configuration of the suspension system.

FIGS. 10 & 11 are rear and perspective views of yet another configuration of the suspension system.

FIGS. 12 & 13 are rear and perspective views of a further configuration of the suspension system.

### DETAILED DESCRIPTION

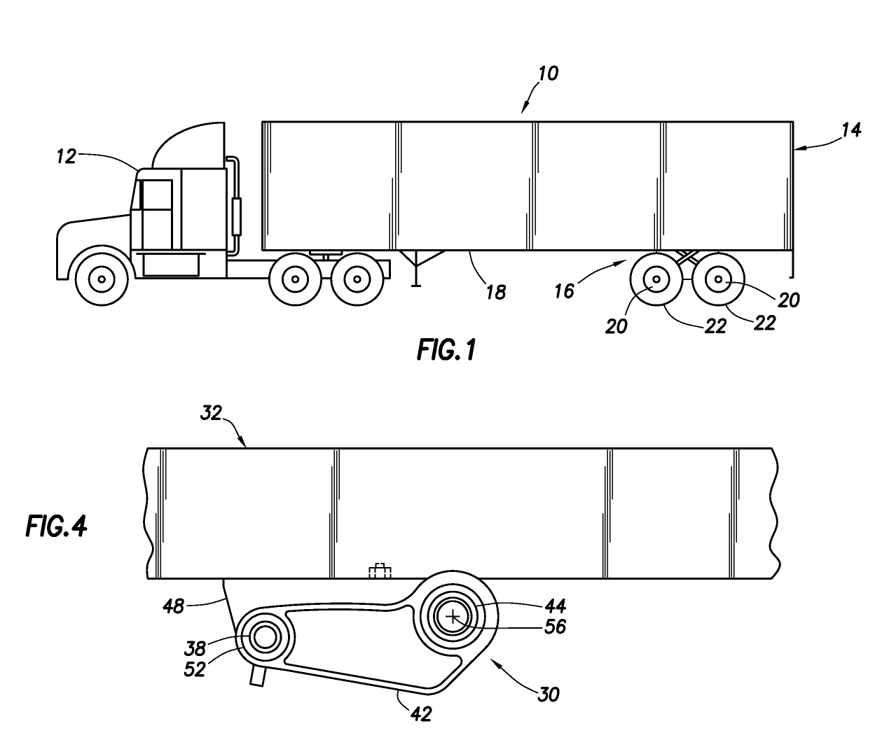

Representatively illustrated in FIG. 1 is a vehicle 10 which can embody principles of this disclosure. The vehicle 10 is depicted as including a tractor 12 and a trailer 14. However, it is contemplated that the principles of this disclosure can be incorporated into a trailer of any type (as well as other types of vehicles), and so the term “vehicle” is used herein to refer to trailers of various types, as well as to refer to self-propelled vehicles.

The trailer 14 of FIG. 1 includes multiple suspension systems 16 which suspend a frame 18 of the trailer above a road surface. Wheels 20 and tires 22 are rotatably mounted at each end of each suspension system 16.

One of the many benefits of the suspension system described in this disclosure is that the vehicle frame 18 can be lowered significantly, thereby providing for increased cargo volume in the trailer 14, the vehicle 10 can have a lower center of gravity, the vertical distance to step into the trailer or unload cargo from the trailer is reduced, etc. Other benefits include reduced cost, reduced weight, increased convenience and reduced time and labor to manufacture the trailer, etc.

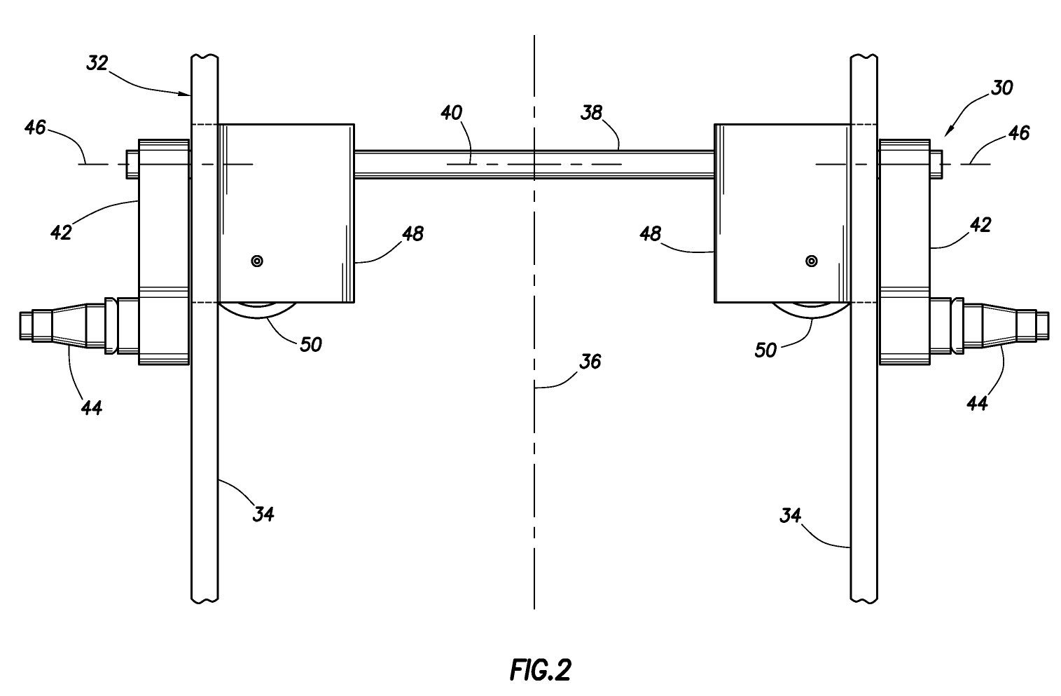

Referring additionally now to FIG. 2, an enlarged scale plan view of a suspension system 30 which may be used for either of the suspension systems 16 on the trailer 14 is representatively illustrated. Of course, the suspension system 30 may be used on other trailers and on other types of vehicles, without departing from the principles of this disclosure.

The suspension system 30 is securely mounted (for example, by welding, fastening, etc.) below a frame 32 of the vehicle. As depicted in FIG. 2, the frame 32 includes two C-channel frame rails 34 which extend longitudinally (e.g., parallel to a longitudinal axis 36 of the vehicle). Other types of frames may be used, if desired.

The suspension system 30 includes a member 38 which extends laterally relative to the vehicle frame 32. As depicted in FIG. 2, an axis 40 of the member 38 is orthogonal to the longitudinal axis 36 of the vehicle and frame 32.

At each opposite end of the member 38, a spindle carrier 42 is pivotably mounted. A spindle 44 extends outwardly from each spindle carrier 42.

The spindles 44 are otherwise conventional, in that they are configured for rotatably mounting wheels (such as wheels 20) thereon. Additional components (such as brakes, bearings, hubs, etc.) may be provided, although they are not depicted in the drawings.

Each spindle carrier 42 uniquely rotates about an axis 46 at each end of the member 38. The axes 46 are preferably parallel to the member axis 40 (and, thus, also orthogonal to the vehicle longitudinal axis 36), and are most preferably collinear with the member axis 40.

In the example of FIG. 2, the spindle carriers 42 rotate about the member 38 itself. One advantage of having the spindle carriers 42 rotatably mounted on the same member 38 is that the entire suspension system 30 (including at least both of the spindle carriers 42) can be simultaneously mounted to the vehicle frame 32, thereby saving expense and labor required for mounting and aligning the suspension system with the frame.

The suspension system 30 is mounted to the frame 32 via hanger brackets 48 which also serve as upper mounts for air springs 50. The air springs 50 serve to resiliently bias the spindle carriers 42 to pivot downwardly relative to the vehicle frame 32. The air springs 50 are compressed by the weight of the vehicle.

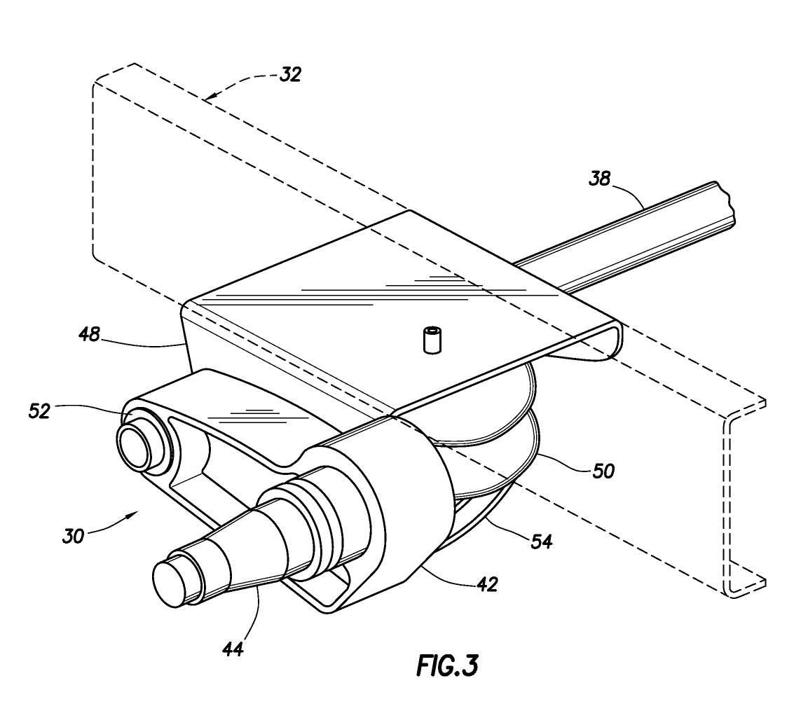

Referring additionally to FIG. 3, a further enlarged rear perspective view of one side of the suspension system 30 is representatively illustrated. In this view, the manner in which the spindle carrier 42 is pivotably mounted on the member 38 is more clearly seen.

Note that the member 38 in this example is a generally tubular cylindrical member. However, other shapes and types of members may be used, if desired.

Each spindle carrier 42 has bushings 52 therein to provide for rotation of the spindle carrier about the member 38. In addition, note that each spindle carrier 42 has an inwardly extending platform 54 formed thereon for mounting the air spring 50.

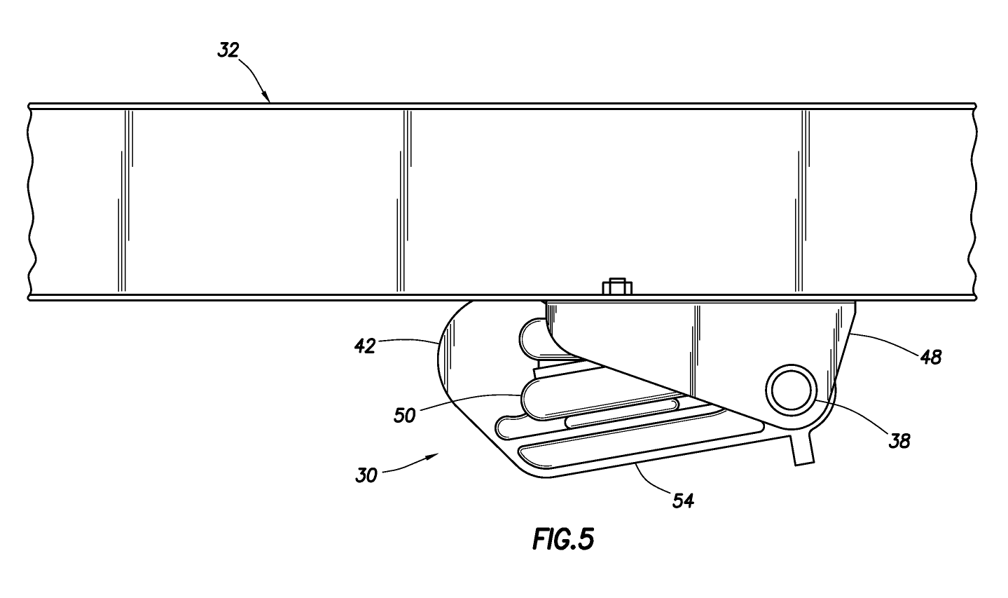

Referring additionally now to FIG. 4, a side view of the suspension system 30 is representatively illustrated. In this view, the reduced vertical distance between the frame 32 and a center 56 of the spindle 44 can be clearly seen. This reduced vertical distance provides many of the benefits discussed above.

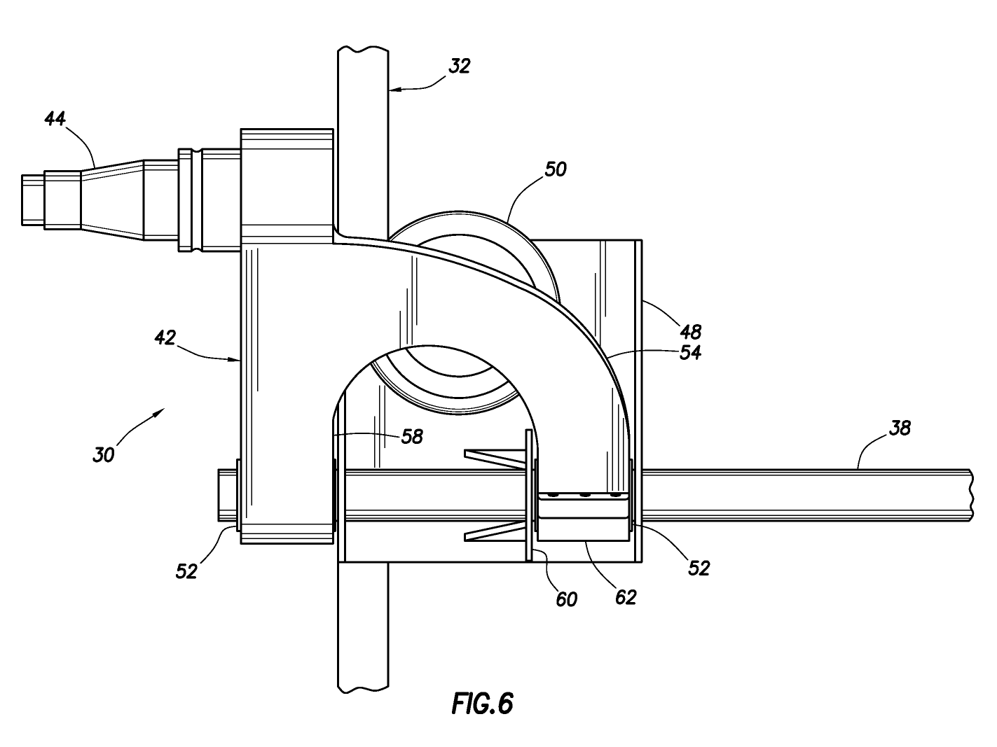

Referring additionally now to FIG. 5, an inner side view of the suspension system 30 is representatively illustrated. In this view, the manner in which the air spring 50 is mounted between the hanger bracket 48 and the platform 54 can be more clearly seen.

The air spring 50 biases the platform 54 downwardly relative to the top plate of the hanger bracket 48 to thereby support the vehicle frame 32. Increased weight on the vehicle frame 32 (or a bump traversed by the associated wheel 20 and tire 22) tends to compress the air spring 50 and pivot the spindle carrier 42 upwardly about the member 38 (i.e., toward the frame 32), and decreased weight on the vehicle frame (or a depression traversed by the associated wheel and tire) tends to decompress the air spring and pivot the spindle carrier downwardly about the member (i.e., away from the frame).

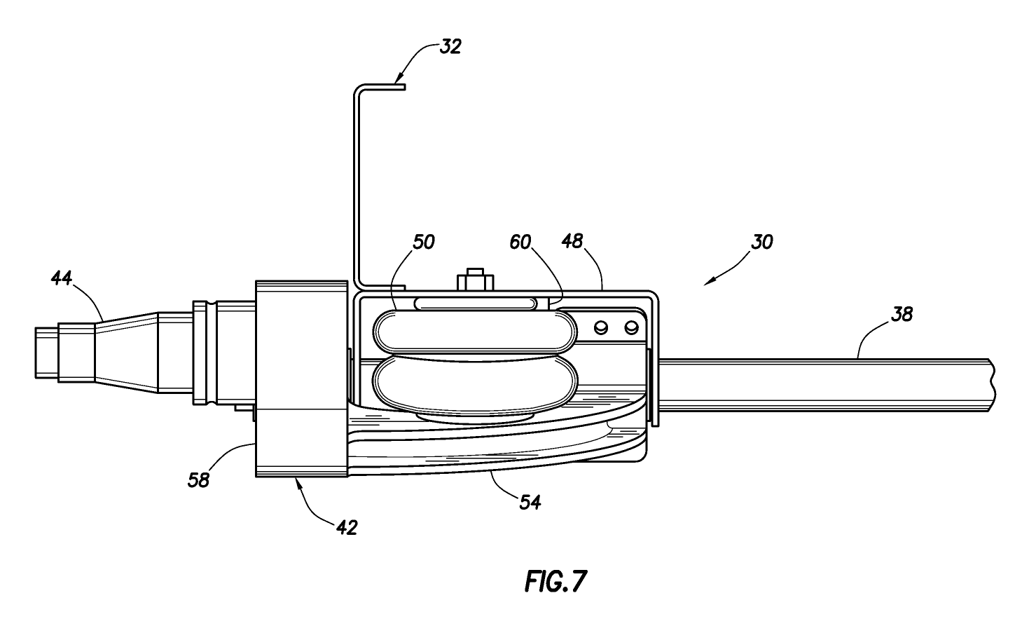

Referring additionally now to FIG. 6, a bottom side view of the suspension system 30 is representatively illustrated. In this view the manner in which the member 38 is secured to the hanger bracket 48, and the manner in which the spindle carrier 42 is rotatably mounted on the member, can be more clearly seen.

Note that the member 38 is secured against rotation relative to the hanger bracket 48 (for example, by welding, fastening, etc.). Since the hanger bracket 48 is rigidly mounted to the frame 32, the member 38 is also secured against rotation or other displacement relative to the frame.

In the example of FIG. 6, the platform 54 is in the shape of an arc extending inwardly from an outer arm 58 of the spindle carrier 42. The platform 54 is pivotably mounted to the member 38 with another bushing 52 which is retained laterally between an inner plate of the hanger bracket 48 and a support bracket 60 mounted under the upper plate of the hanger bracket. A retainer cap 62 secures the bushing 52 to the platform 54.

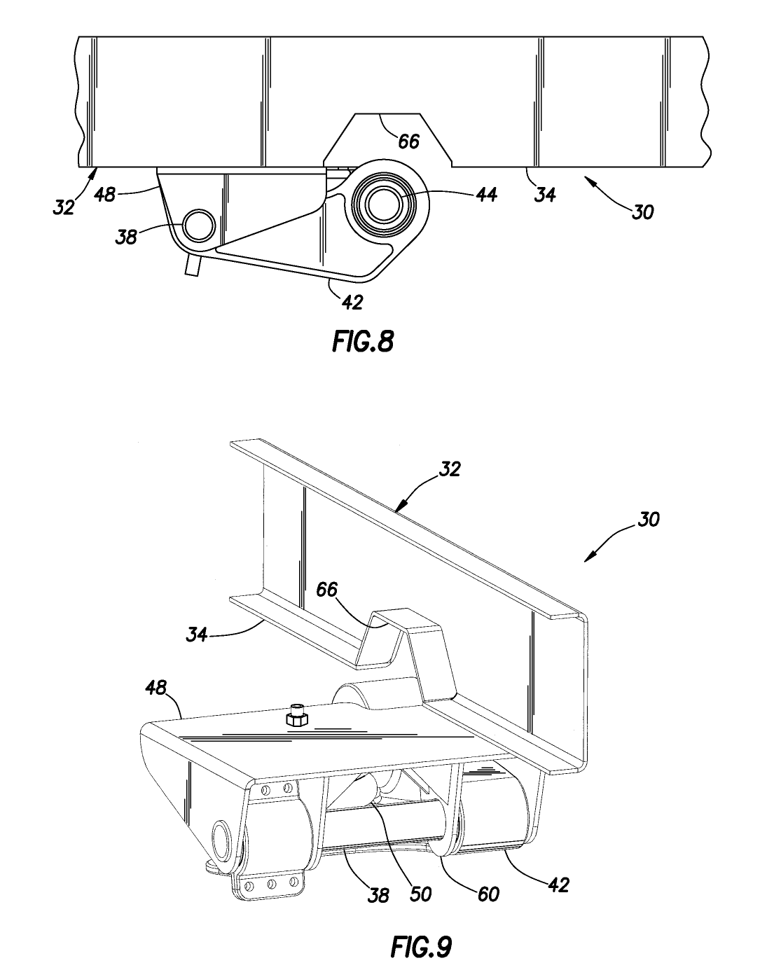

Referring additionally now to FIG. 7, a rear view of the suspension system 30 is representatively illustrated. In this view the spatial relationship between the air spring 50, the hanger bracket 48 and the platform 54 may be more clearly seen.

Note that the hanger bracket 48, along with the support bracket 60, operates to laterally retain the spindle carrier 42 on the member 38, while also allowing the spindle carrier to rotate freely about the member.

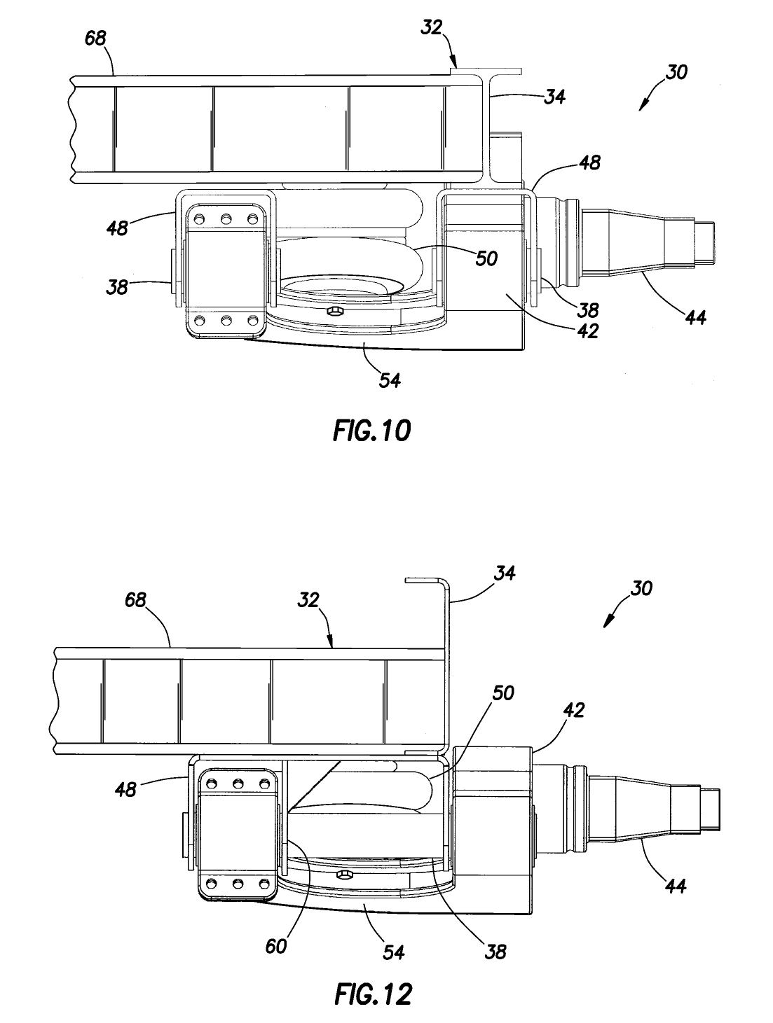

It is not necessary in keeping with the principles of this disclosure for the member 38 to extend completely laterally across the frame 32 (e.g., between the frame rails 34, as depicted in FIG. 2). Instead, one or more separate members 38 may be provided on each lateral side of the trailer 14. FIGS. 8-13 representatively illustrate several examples of this, and demonstrate that a variety of configurations of the suspension system 30 are possible, without departing from the principles of this disclosure.

In FIGS. 8 & 9, a configuration of the suspension system 30 is representatively illustrated, in which the member 38 extends from one side of the hanger bracket 48 to the other, but the member does not extend completely across the frame 32 (e.g., to the opposing frame rail 34). Thus, a separate suspension system 30 can be individually attached to each frame rail 34.

Another difference in the suspension system 30 as depicted in FIGS. 8 & 9 is that the spindle carrier 42 is positioned directly under the frame rail 34. A notched recess 66 is formed in the frame rail 34 to accommodate the vertical travel of the spindle carrier 42. This provides for a more vertically and laterally compact suspension system 30.

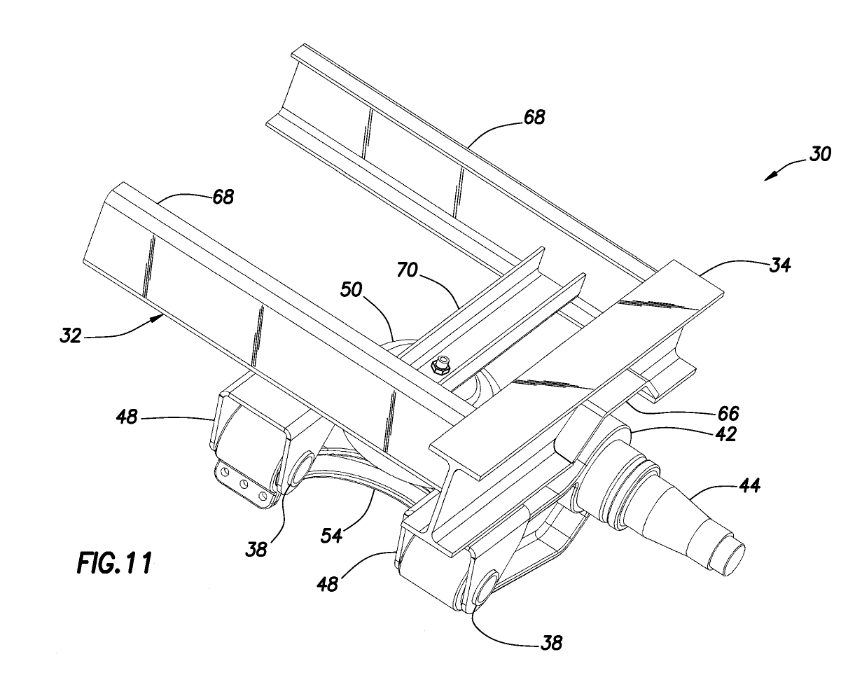

In FIGS. 10 & 11, a configuration of the suspension system 30 is representatively illustrated, in which multiple members 38 and hanger brackets 48 are used on each side of the frame 32. The hanger brackets 48 are attached to a cross-member 68 which extends laterally between the frame rails 34. The upper end of the air spring 50 is secured to another rail 70 which is attached to two of the cross-members 68.

Another difference in the configuration of FIGS. 10 & 11 is that the frame rail 34 is in the form of an I-beam having the notched recess 66 formed therein. One of the hanger brackets 48 is attached to the frame rail 34, and another of the hanger brackets is attached to one of the cross-members 68. The hanger brackets 48 and members 38 are, thus, laterally spaced apart relative to the frame 32.

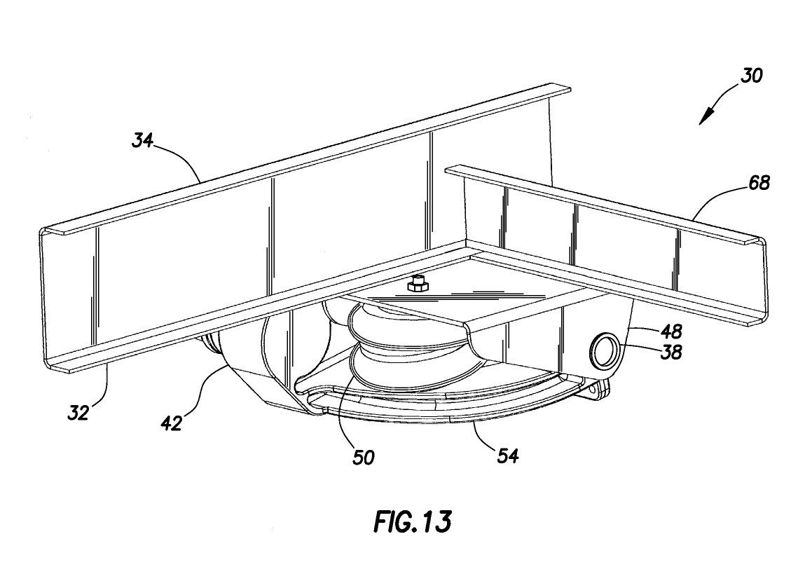

In FIGS. 12 & 13, a configuration of the suspension system 30 is representatively illustrated, in which the member 38 does not extend completely laterally across the frame 32, but a cross-member 68 does extend from one frame rail 34 to the other, and a hanger bracket is attached to the frame rail 34 and cross-member 68 on each side of the frame. The configuration of FIGS. 12 & 13 is otherwise substantially similar to the configuration of FIGS. 2-7.

It may now be fully appreciated that the suspension system 30 as described herein provides many advancements to the art. In particular, the suspension system 30 is fairly straightforward in design, requiring relatively few components to perform its function, while still providing a capable means of reliably suspending the vehicle frame 32 above a road surface. The suspension system 30 is relatively inexpensive and convenient to manufacture and install.

The above disclosure describes a suspension system 30 for a vehicle. The suspension system 30 includes a member 38 which extends laterally relative to a frame 32 of the vehicle. At least one spindle carrier 42 pivots about the member 38.

The suspension system 30 can include two spindle carriers 42, with each of the spindle carriers being pivotably mounted on the member 38. Each of the spindle carriers 42 may be pivotably mounted at a respective opposite end of the member 38. The spindle carriers 42 may be spaced apart from each other on the member 38.

The spindle carrier 42 may rotate about an axis 40 of the member 38. The spindle carrier 42 may rotate relative to the member 38. The member 38 may be secured against rotation relative to the vehicle frame 32.

Also described by the above disclosure is a suspension system 30 for a vehicle which includes a member 38 which extends laterally relative to a frame 32 of the vehicle, and at least two spindle carriers 42, with each of the spindle carriers 42 being pivotably mounted at a respective opposite end of the member 38.

The spindle carriers 42 may rotate about the member 38. The spindle carriers 42 may rotate relative to the member 38.

The above disclosure also provides a suspension system 30 for a vehicle which includes a member 38 which extends laterally relative to a frame 32 of the vehicle, with the member having an axis 40. At least one spindle carrier 42 rotates about an axis 46 which is collinear with and/or parallel to the member axis 40. The member axis 40 may be orthogonal to a longitudinal axis 36 of the vehicle frame 32.

The suspension system 30 may comprise multiple spindle carriers 42 and multiple members 38. The spindle carriers 42 and respective members 38 may be attached on opposite lateral sides of the frame 32. Each member 38 may extend less than completely laterally across the frame 32.

Of course, a person skilled in the art would, upon a careful consideration of the above description of representative embodiments, readily appreciate that many modifications, additions, substitutions, deletions, and other changes may be made to these specific embodiments, and such changes are within the scope of the principles of the present disclosure. Accordingly, the foregoing detailed description is to be clearly understood as being given by way of illustration and example only, the spirit and scope of the present invention being limited solely by the appended claims and their equivalents.

What is claimed is:

1. A suspension system for a vehicle, the suspension system comprising:
a member which extends laterally relative to a frame of the vehicle; and
at least one spindle carrier which pivots about the member.

2. The suspension system of claim 1, wherein the at least one spindle carrier comprises first and second spindle carriers, each of the first and second spindle carriers being pivotably mounted on the member.

3. The suspension system of claim 2, wherein each of the first and second spindle carriers is pivotably mounted at a respective opposite end of the member.

4. The suspension system of claim 2, wherein the first and second spindle carriers are spaced apart from each other on the member.

5. The suspension system of claim 1, wherein the at least one spindle carrier rotates about an axis of the member.

6. The suspension system of claim 1, wherein the at least one spindle carrier rotates relative to the member.

7. The suspension system of claim 1, wherein the member is secured against rotation relative to the vehicle frame.

8. A suspension system for a vehicle, the suspension system comprising:
a member which extends laterally relative to a frame of the vehicle; and
first and second spindle carriers, each of the first and second spindle carriers being pivotably mounted at a respective opposite end of the member.

9. The suspension system of claim 8, wherein the first and second spindle carriers rotate about an axis of the member.

10. The suspension system of claim 8, wherein the first and second spindle carriers rotate about the member.

11. The suspension system of claim 8, wherein the first and second spindle carriers rotate relative to the member.

12. The suspension system of claim 8, wherein the member is secured against rotation relative to the vehicle frame.

13. A suspension system for a vehicle, the suspension system comprising:
at least one member which extends laterally relative to a frame of the vehicle, the member having an axis; and
at least one spindle carrier which rotates about an axis which is at least one of collinear and parallel to the member axis.

14. The suspension system of claim 13, wherein the member axis is orthogonal to a longitudinal axis of the vehicle frame.

15. The suspension system of claim 13, wherein the at least one spindle carrier comprises first and second spindle carriers, each of the first and second spindle carriers being pivotably mounted on the member.

16. The suspension system of claim 15, wherein each of the first and second spindle carriers is pivotably mounted at a respective opposite end of the member.

17. The suspension system of claim 15, wherein the first and second spindle carriers are spaced apart from each other on the member.

18. The suspension system of claim 13, wherein the at least one spindle carrier rotates relative to the member.

19. The suspension system of claim 13, wherein the member is secured against rotation relative to the vehicle frame.

20. The suspension system of claim 13, wherein the at least one spindle carrier comprises multiple spindle carriers, wherein the at least one member comprises multiple members, and wherein the spindle carriers and respective members are attached on opposite lateral sides of the frame.

21. The suspension system of claim 13, wherein the member extends less than completely laterally across the frame.
